(19) United States
(12) Patent Application Publication
(10) Pub. No.: US 2015/0365761 A1
(43) Pub. Date: Dec. 17, 2015

(54) SYSTEMS AND METHODS FOR SELECTIVELY ENABLING AND DISABLING ADAPTATION OF AN ADAPTIVE NOISE CANCELLATION SYSTEM

(71) Applicant: CIRRUS LOGIC, INC., AUSTIN, TX (US)

(72) Inventors: Jeffrey D. Alderson, Austin, TX (US); Jon D. Hendrix, Wimberley, TX (US); Dayong Zhou, Austin, TX (US)

(21) Appl. No.: 14/304,208

(22) Filed: Jun. 13, 2014

(51) Int. Cl. H04R 3/00

(52) U.S. Cl. CPC H04R 3/002

(57) ABSTRACT

In accordance with the present disclosure, an adaptive noise cancellation system may include a controller. The controller may be configured to determine a degree of convergence of an adaptive coefficient control block for controlling an adaptive response of the adaptive noise cancellation system. The controller may enable adaptation of the adaptive coefficient control block if the degree of convergence of the adaptive response is below a particular threshold and disable adaptation of the adaptive coefficient control block if the degree of convergence of the adaptive response is above a particular threshold, such that when the adaptive noise cancellation system is adequately converged, the adaptive noise cancellation system may conserve power by disabling one or more of its components.

### FIELD OF DISCLOSURE

The present disclosure relates in general to adaptive noise cancellation in connection with an acoustic transducer, and more particularly, multi-mode adaptive cancellation for audio headsets.

### BACKGROUND

Wireless telephones, such as mobile/cellular telephones, cordless telephones, and other consumer audio devices, such as mp3 players, are in widespread use. Performance of such devices with respect to intelligibility can be improved by providing noise canceling using a microphone to measure ambient acoustic events and then using signal processing to insert an anti-noise signal into the output of the device to cancel the ambient acoustic events.

In an adaptive noise cancellation system, it is often desirable for the system to be fully adaptive such that a maximum noise cancellation effect is provided to a user at all times. However, when an adaptive noise cancellation system is adapting, it consumes more power than when it is not adapting. Therefore, it may be desirable to have a system that can determine when adaptation is needed, and only adapt during such times in order to reduce power consumption.

### SUMMARY

In accordance with the teachings of the present disclosure, certain disadvantages and problems associated with power consumption of an adaptive noise cancellation system may be reduced or eliminated.

In accordance with embodiments of the present disclosure, an integrated circuit for implementing at least a portion of a personal audio device may include an output, an error microphone input, and a processing circuit. The output may be configured to provide an output signal to a transducer including both a source audio signal for playback to a listener and an anti-noise signal for countering the effect of ambient audio sounds in an acoustic output of the transducer. The error microphone input may be configured to receive an error microphone signal indicative of the output of the transducer and the ambient audio sounds at the transducer. The processing circuit may implement an anti-noise generating filter, a secondary path estimate filter, and a controller. The anti-noise generating filter may have a response that generates the anti-noise signal based at least on the reference microphone signal. The secondary path estimate filter may be configured to model an electro-acoustic path of the source audio signal and have a response that generates a secondary path estimate from the source audio signal, wherein at least one of the response of the anti-noise generating filter and the response of the secondary path estimate filter is an adaptive response shaped by an adaptive coefficient control block. The adaptive coefficient control block may include at least one of a filter coefficient control block that shapes the response of the anti-noise generating filter by adapting the response of the anti-noise generating filter to minimize the ambient audio sounds in the error microphone signal and a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate. The controller may be configured to determine a degree of convergence of the adaptive response, enable adaptation of the adaptive coefficient control block if the degree of convergence of the adaptive response is below a particular threshold, and disable adaptation of the adaptive coefficient control block if the degree of convergence of the adaptive response is above a particular threshold.

In accordance with these and other embodiments of the present disclosure, a method for canceling ambient audio sounds in the proximity of a transducer of a personal audio device may include receiving an error microphone signal indicative of an acoustic output of the transducer and the ambient audio sounds at the transducer. The method may further include adaptively generating an anti-noise signal to reduce the presence of the ambient audio sounds heard by the listener by adapting an adaptive response of an adaptive noise cancellation system to minimize the ambient audio sounds at the acoustic output of the transducer, wherein adaptively generating the anti-noise signal comprises generating the anti-noise signal from based on at least the error microphone signal with an anti-noise generating filter, generating a secondary path estimate from the source audio signal with a secondary path estimate filter for modeling an electro-acoustic path of a source audio signal, and at least one of: (i) adaptively generating the anti-noise signal by shaping a response of the anti-noise generating filter by adapting the response of the anti-noise generating filter to minimize the ambient audio sounds in the error microphone signal, wherein the adaptive response comprises the response of the anti-noise generating filter; and (ii) adaptively generating the secondary path estimate by shaping a response of the secondary path estimate filter in conformity with the source audio signal and a playback corrected error by adapting the response of the secondary path estimate filter to minimize the playback corrected error, wherein the playback corrected error is based on a difference between the error microphone signal and the secondary path estimate, wherein the adaptive response comprises the response of the secondary path estimate filter. The method may additionally include combining the anti-noise signal with a source audio signal to generate an output signal provided to the transducer. The method may further include determining a degree of convergence of the adaptive response, enabling adaptation of the adaptive response if the degree of convergence of the adaptive response is below a particular threshold, and disabling adaptation of the adaptive response if the degree of convergence of the adaptive response is above a particular threshold.

In accordance with these and other embodiments of the present disclosure, a personal audio device may include a transducer and an error microphone. The transducer may be configured to reproduce an output signal including both a source audio signal for playback to a listener and an anti-noise signal for countering the effects of ambient audio sounds in an acoustic output of the transducer. The error microphone may be configured to generate an error microphone signal indicative of the output of the transducer and the ambient audio sounds at the transducer. The processing circuit may implement an anti-noise generating filter, a secondary path estimate filter, and a controller. The anti-noise generating filter may have a response that generates the anti-noise signal based at least on the reference microphone signal. The secondary path estimate filter may be configured to model an electro-acoustic path of the source audio signal and have a response that generates a secondary path estimate from the source audio signal, wherein at least one of the response of the anti-noise generating filter and the response of the secondary path estimate filter is an adaptive response shaped by an adaptive coefficient control block. The adaptive coefficient control block may include at least one of a filter coefficient control block that shapes the response of the anti-noise generating filter by adapting the response of the anti-noise generating filter to minimize the ambient audio sounds in the error microphone signal and a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate. The controller may be configured to determine a degree of convergence of the adaptive response, enable adaptation of the adaptive coefficient control block if the degree of convergence of the adaptive response is below a particular threshold, and disable adaptation of the adaptive coefficient control block if the degree of convergence of the adaptive response is above a particular threshold.

In accordance with these and other embodiments of the present disclosure, an integrated circuit for implementing at least a portion of a personal audio devic may include a controller configured to determine a degree of convergence of an adaptive response of an adaptive filter in an adaptive noise cancellation system, enable adaptation of the adaptive response if the degree of convergence of the adaptive response is below a particular threshold, and disable adaptation of the adaptive response if the degree of convergence of the adaptive response is above a particular threshold.

Technical advantages of the present disclosure may be readily apparent to one of ordinary skill in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is an illustration of an example wireless mobile telephone, in accordance with embodiments of the present disclosure;

FIG. 1B is an illustration of an example wireless mobile telephone with a headphone assembly coupled thereto, in accordance with embodiments of the present disclosure;

FIG. 2 is a block diagram of selected circuits within the wireless mobile telephone depicted in FIG. 1, in accordance with embodiments of the present disclosure;

FIG. 3 is a block diagram depicting selected signal processing circuits and functional blocks within an example adaptive noise canceling (ANC) circuit of a coder-decoder (CODEC) integrated circuit of FIG. 2 which uses feedforward filtering to generate an anti-noise signal, in accordance with embodiments of the present disclosure;

FIG. 4 is a flow chart of an example method for selectively enabling and disabling adaptation of an ANC circuit based on monitoring of an adaptive response of a feedforward filter W(z), in accordance with embodiments of the present disclosure;

FIG. 5 is a flow chart of an example method for selectively enabling and disabling adaptation of an ANC circuit based on monitoring of an adaptive response of a secondary path estimate filter, in accordance with embodiments of the present disclosure;

FIG. 6 is a flow chart of an example method for selectively enabling and disabling adaptation of an ANC circuit based on monitoring of adaptive responses of a feedforward filter and a secondary path estimate filter, in accordance with embodiments of the present disclosure;

FIG. 7 is a flow chart of an example method for selectively enabling and disabling adaptation of an ANC circuit based on monitoring of an adaptive noise cancellation gain of the ANC circuit, in accordance with embodiments of the present disclosure;

FIG. 8 is a flow chart of an example method for selectively enabling and disabling adaptation of an ANC circuit based on monitoring of a secondary path estimate filter cancellation gain of the ANC circuit, in accordance with embodiments of the present disclosure; and

FIG. 9 is a block diagram depicting selected signal processing circuits and functional blocks within an example adaptive noise canceling (ANC) circuit of a coder-decoder (CODEC) integrated circuit of FIG. 2 which uses feedback filtering to generate an anti-noise signal, in accordance with embodiments of the present disclosure.

### DETAILED DESCRIPTION

The present disclosure encompasses noise canceling techniques and circuits that can be implemented in a personal audio device, such as a wireless telephone. The personal audio device includes an ANC circuit that may measure the ambient acoustic environment and generate a signal that is injected in the speaker (or other transducer) output to cancel ambient acoustic events. A reference microphone may be provided to measure the ambient acoustic environment and an error microphone may be included for controlling the adaptation of the anti-noise signal to cancel the ambient audio sounds and for correcting for the electro-acoustic path from the output of the processing circuit through the transducer.

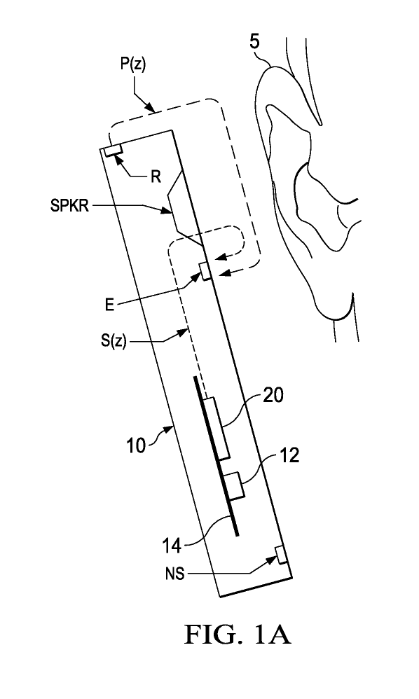

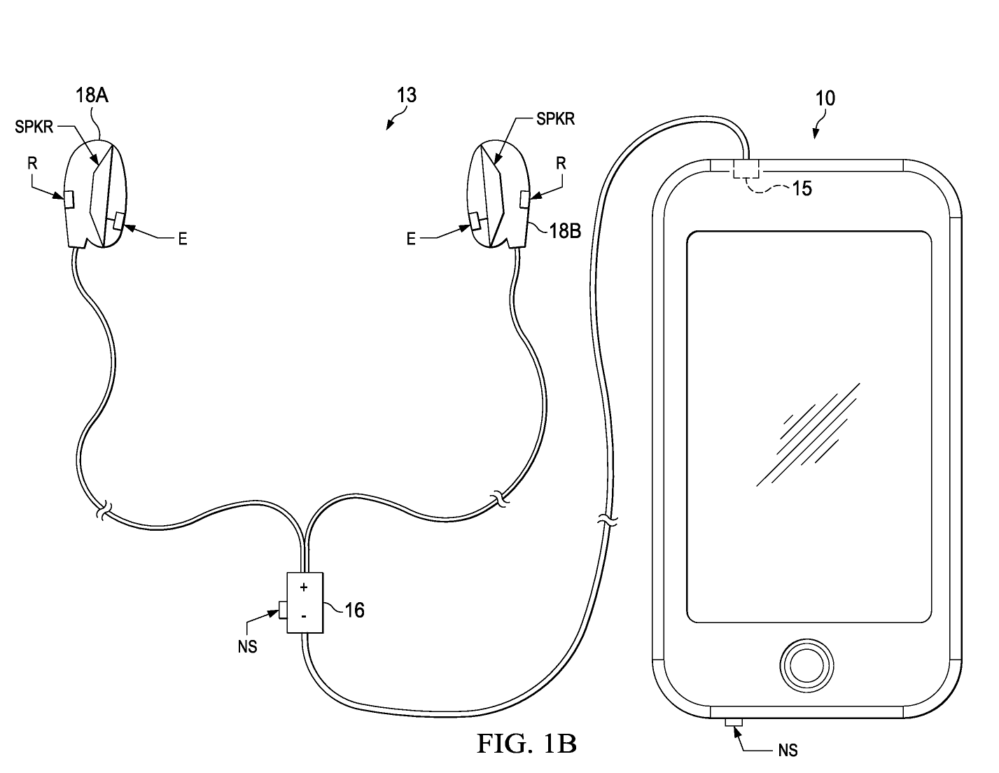

Referring now to FIG. 1A, a wireless telephone 10 as illustrated in accordance with embodiments of the present disclosure is shown in proximity to a human ear 5. Wireless telephone 10 is an example of a device in which techniques in accordance with embodiments of this disclosure may be employed, but it is understood that not all of the elements or configurations embodied in illustrated wireless telephone 10, or in the circuits depicted in subsequent illustrations, are required in order to practice the inventions recited in the claims. Wireless telephone 10 may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. A near-speech microphone NS may be provided to capture near-end speech, which is transmitted from wireless telephone 10 to the other conversation participant(s).

Wireless telephone 10 may include ANC circuits and features that inject an anti-noise signal into speaker SPKR to improve intelligibility of the distant speech and other audio reproduced by speaker SPKR. A reference microphone R may be provided for measuring the ambient acoustic environment, and may be positioned away from the typical position of a user's mouth, so that the near-end speech may be minimized in the signal produced by reference microphone R. Another microphone, error microphone E, may be provided in order to further improve the ANC operation by providing a measure of the ambient audio combined with the audio reproduced by speaker SPKR close to ear 5, when wireless telephone 10 is in close proximity to ear 5. In other embodiments, additional reference and/or error microphones may be employed. Circuit 14 within wireless telephone 10 may include an audio CODEC integrated circuit (IC) 20 that receives the signals from reference microphone R, near-speech microphone NS, and error microphone E and interfaces with other integrated circuits such as a radio-frequency (RF) integrated circuit 12 having a wireless telephone transceiver. In some embodiments of the disclosure, the circuits and techniques disclosed herein may be incorporated in a single integrated circuit that includes control circuits and other functionality for implementing the entirety of the personal audio device, such as an MP3 player-on-a-chip integrated circuit. In these and other embodiments, the circuits and techniques disclosed herein may be implemented partially or fully in software and/or firmware embodied in computer-readable media and executable by a controller or other processing device.

In general, ANC techniques of the present disclosure measure ambient acoustic events (as opposed to the output of speaker SPKR and/or the near-end speech) impinging on reference microphone R, and by also measuring the same ambient acoustic events impinging on error microphone E, ANC processing circuits of wireless telephone 10 adapt an anti-noise signal generated from the output of reference microphone R to have a characteristic that minimizes the amplitude of the ambient acoustic events at error microphone E. Because acoustic path P(z) extends from reference microphone R to error microphone E, ANC circuits are effectively estimating acoustic path P(z) while removing effects of an electro-acoustic path S(z) that represents the response of the audio output circuits of CODEC IC 20 and the acoustic/electric transfer function of speaker SPKR including the coupling between speaker SPKR and error microphone E in the particular acoustic environment, which may be affected by the proximity and structure of ear 5 and other physical objects and human head structures that may be in proximity to wireless telephone 10, when wireless telephone 10 is not firmly pressed to ear 5. While the illustrated wireless telephone 10 includes a two-microphone ANC system with a third near-speech microphone NS, some aspects of the present invention may be practiced in a system that does not include separate error and reference microphones, or a wireless telephone that uses near-speech microphone NS to perform the function of the reference microphone R. Also, in personal audio devices designed only for audio playback, near-speech microphone NS will generally not be included, and the near-speech signal paths in the circuits described in further detail below may be omitted, without changing the scope of the disclosure, other than to limit the options provided for input to the microphone.

Referring now to FIG. 1B, wireless telephone 10 is depicted having a headphone assembly 13 coupled to it via audio port 15. Audio port 15 may be communicatively coupled to RF integrated circuit 12 and/or CODEC IC 20, thus permitting communication between components of headphone assembly 13 and one or more of RF integrated circuit 12 and/or CODEC IC 20. As shown in FIG. 1B, headphone assembly 13 may include a combox 16, a left headphone 18A, and a right headphone 18B. As used in this disclosure, the term “headphone” broadly includes any loudspeaker and structure associated therewith that is intended to be mechanically held in place proximate to a listener's ear canal, and includes without limitation earphones, earbuds, and other similar devices. As more specific examples, “headphone” may refer to intra-concha earphones, supra-concha earphones, and supra-aural earphones.

Combox 16 or another portion of headphone assembly 13 may have a near-speech microphone NS to capture near-end speech in addition to or in lieu of near-speech microphone NS of wireless telephone 10. In addition, each headphone 18A, 18B may include a transducer such as speaker SPKR that reproduces distant speech received by wireless telephone 10, along with other local audio events such as ringtones, stored audio program material, injection of near-end speech (i.e., the speech of the user of wireless telephone 10) to provide a balanced conversational perception, and other audio that requires reproduction by wireless telephone 10, such as sources from webpages or other network communications received by wireless telephone 10 and audio indications such as a low battery indication and other system event notifications. Each headphone 18A, 18B may include a reference microphone R for measuring the ambient acoustic environment and an error microphone E for measuring of the ambient audio combined with the audio reproduced by speaker SPKR close to a listener's ear when such headphone 18A, 18B is engaged with the listener's ear. In some embodiments, CODEC IC 20 may receive the signals from reference microphone R, near-speech microphone NS, and error microphone E of each headphone and perform adaptive noise cancellation for each headphone as described herein. In other embodiments, a CODEC IC or another circuit may be present within headphone assembly 13, communicatively coupled to reference microphone R, near-speech microphone NS, and error microphone E, and configured to perform adaptive noise cancellation as described herein.

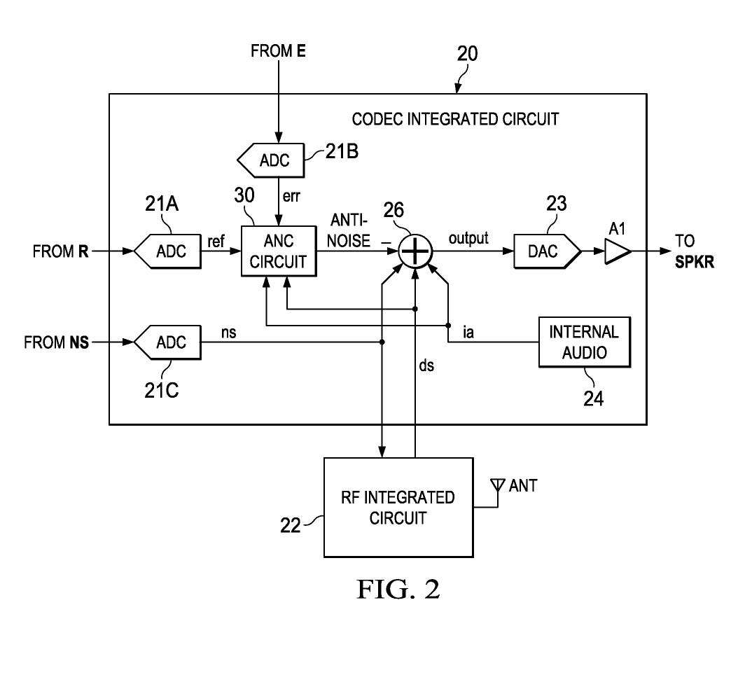

Referring now to FIG. 2, selected circuits within wireless telephone 10 are shown in a block diagram, which in other embodiments may be placed in whole or in part in other locations such as one or more headphones or earbuds. CODEC IC 20 may include an analog-to-digital converter (ADC) 21A for receiving the reference microphone signal from microphone R and generating a digital representation ref of the reference microphone signal, an ADC 21B for receiving the error microphone signal from erro microphone E and generating a digital representation err of the error microphone signal, and an ADC 21C for receiving the near speech microphone signal from near speech microphone NS and generating a digital representation ns of the near speech microphone signal. CODEC IC 20 may generate an output for driving speaker SPKR from an amplifier A1, which may amplify the output of a digital-to-analog converter (DAC) 23 that receives the output of a combiner 26. Combiner 26 may combine audio signals is from internal audio sources 24, the anti-noise signal generated by ANC circuit 30, which by convention has the same polarity as the noise in reference microphone signal ref and is therefore subtracted by combiner 26, and a portion of near speech microphone signal ns so that the user of wireless telephone 10 may hear his or her own voice in proper relation to downlink speech ds, which may be received from radio frequency (RF) integrated circuit 22 and may also be combined by combiner 26. Near speech microphone signal ns may also be provided to RF integrated circuit 22 and may be transmitted as uplink speech to the service provider via antenna ANT.

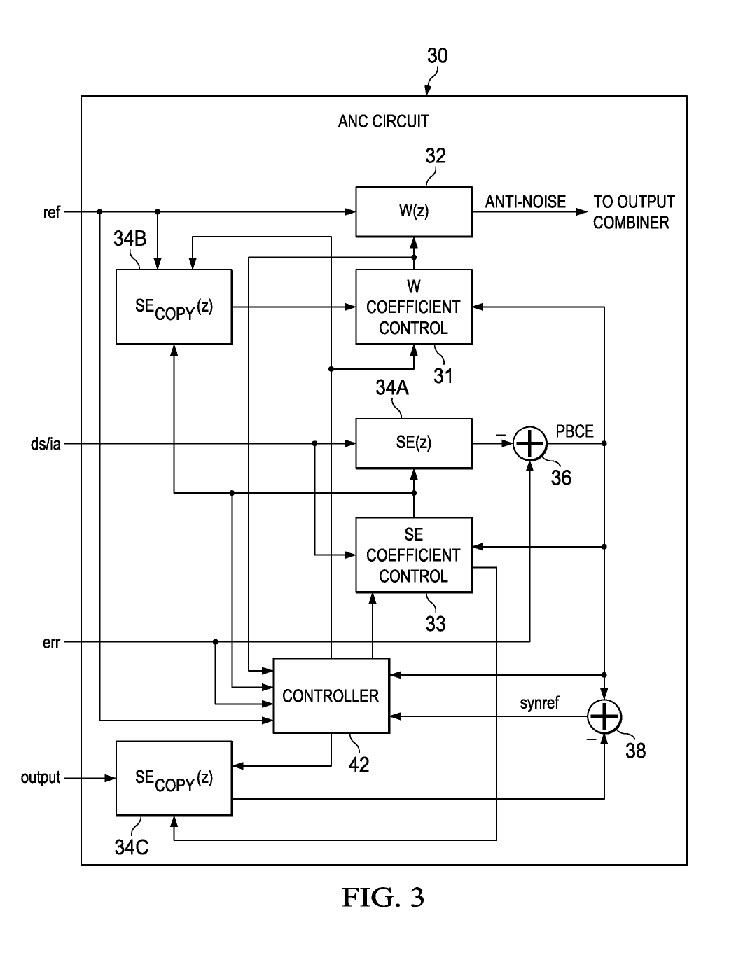

Referring now to FIG. 3, details of ANC circuit 30 are shown in accordance with embodiments of the present disclosure. Adaptive filter 32 may receive reference microphone signal ref and under ideal circumstances, may adapt its transfer function W(z) to be P(z)/S(z) to generate the anti-noise signal, which may be provided to an output combiner that combines the anti-noise signal with the audio to be reproduced by the transducer, as exemplified by combiner 26 of FIG. 2. The coefficients of adaptive filter 32 may be controlled by a W coefficient control block 31 that uses a correlation of signals to determine the response of adaptive filter 32, which generally minimizes the error, in a least-mean squares sense, between those components of reference microphone signal ref present in error microphone signal err. The signals compared by W coefficient control block 31 may be the reference microphone signal ref as shaped by a copy of an estimate of the response of path S(z) provided by filter 34B and a playback corrected error, labeled as “PBCE” in FIG. 3, based at least in part on error microphone signal err. The playback corrected error may be generated as described in greater detail below. By transforming reference microphone signal ref with a copy of the estimate of the response of path S(z), response SE_{COPY}(z) of filter 34B, and minimizing the difference between the resultant signal and error microphone signal err, adaptive filter 32 may adapt to the desired response of P(z)/S(z). In addition to error microphone signal err, the playback corrected error signal compared to the output of filter 34B by W coefficient control block 31 may include an inverted amount of source audio signal (e.g., downlink audio signal ds and/or internal audio signal ia), that has been processed by filter response SE(z), of which response SE_{COPY}(z) is a copy. By injecting an inverted amount of source audio signal, adaptive filter 32 may be prevented from adapting to the relatively large amount of source audio signal present in error microphone signal err. However, by transforming that inverted copy of the source audio signal with the estimate of the response of path S(z), the source audio that is removed from error microphone signal err should match the expected version of the source audio signal reproduced at error microphone signal err, because the electrical and acoustical path of S(z) is the path taken by the source audio signal to arrive at error microphone E. Filter 34B may not be an adaptive filter, per se, but may have an adjustable response that is tuned to match the response of adaptive filter 34A, so that the response of filter 34B tracks the adapting of adaptive filter 34A.

To implement the above, adaptive filter 34A may have coefficients controlled by SE coefficient control block 33, which may compare the source audio signal and a playback corrected error. The playback corrected error may be equal to error microphone signal err after removal of the equalized source audio signal (as filtered by filter 34A to represent the expected playback audio delivered to error microphone E) by a combiner 36. SE coefficient control block 33 may correlate the actual equalized source audio signal with the components of the equalized source audio signal that are present in error microphone signal err. Adaptive filter 34A may thereby be adapted to generate a secondary estimate signal from the equalized source audio signal, that when subtracted from error microphone signal err to generate the playback corrected error, includes the content of error microphone signal err that is not due to the equalized source audio signal.

Also as shown in FIG. 3, ANC circuit 30 may include a controller 42. As described in greater detail below, controller 42 may be configured to determine a degree of convergence of an adaptive response (e.g., response W(z) and/or response SE(z)) of ANC circuit 30. Such determination may be made based on one or more signals associated with ANC circuit 30, including without limitation the audio output signal, reference microphone signal ref, error microphone signal err, the playback corrected error, coefficients generated by W coefficient control block 31, and coefficients generated by SE coefficient control block 33. For purposes of this disclosure, “convergence” of an adaptive response may generally mean a state in which such adaptive response substantially unchanging over a period of time. For example, if the ambient environment around a personal audio device (e.g., wireless telephone) is predominantly static, adaptation of an adaptive response of ANC circuit 30 may be minimal in the sense that such response may not change significantly over a period of time. Thus a “degree of convergence” may be a measure of the extent to which an adaptive response adapts over a period of time.

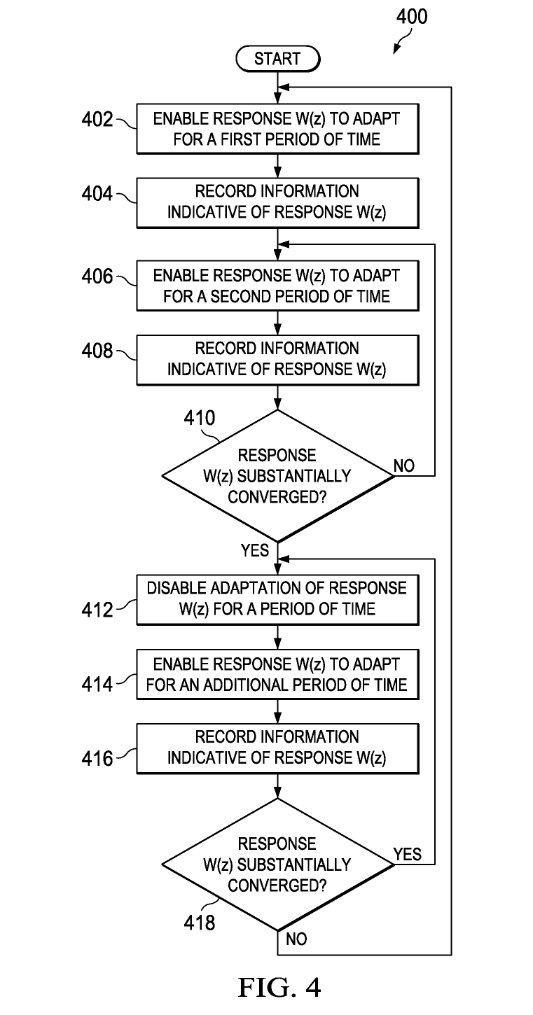

If the degree of convergence of the adaptive response is below a particular threshold (e.g., the adaptive response is adapting over a period of time in excess of a threshold level of adaptation), controller 42 may enable adaptation of the adaptive response. On the other hand, if the degree of convergence of the adaptive response is above a particular threshold (e.g., the adaptive response is adapting over a period of time less than a threshold level of adaptation), controller 42 may disable adaptation of the adaptive response. Example approaches for determining a degree of convergence and the particular thresholds relevant to such approaches may be described in greater detail below in reference to FIGS. 4-8.

In some embodiments, controller 42 may disable adaptation of an adaptive response by disabling a coefficient control block (e.g., W coefficient control block 31 and/or SE coefficient control block 33) associated with the adaptive response. In these and other embodiments, controller 42 may disable adaptation of an adaptive response (e.g., response W(z)) by disabling filter 34B and/or filter 34C (filter 34C is described in greater detail below). In these and other embodiments, controller 42 may disable adaptation of an adaptive response (e.g., W(z)) by disabling oversight detectors of ANC circuit 30 used to ensure stability in the adaptation of response W(z).

In some embodiments, controller 42 may, as described in greater detail below with respect to FIGS. 4-6, be configured to determine a degree of convergence of an adaptive response (e.g., W(z) and/or SE(z)) by adapting the adaptive response for a first period of time, determining coefficients of an adaptive coefficient control block (e.g., W coefficient control block 31 and/or SE coefficient control block 33) associated with the adaptive response at the end of the first period of time, adapting the adaptive response for a second period of time, determining coefficients of the adaptive coefficient control block at the end of the second period of time, and comparing the coefficients of the adaptive coefficient control block at the end of the first period of time to the coefficients of the adaptive coefficient control block at the end of the second period of time. For example, controller 42 may determine the degree of convergence to be above the particular threshold if the coefficients of the adaptive coefficient control block at the end of the second period of time are within a threshold error of the coefficients of the adaptive coefficient control block at the end of the first period of time, and responsive to such determination, disable adaptation of the adaptive response (e.g., W(z) and/or SE(z)). Similarly, controller 42 may determine the degree of convergence to be below the particular threshold if the coefficients of the adaptive coefficient control block at the end of the second period of time are not within the threshold error, and responsive to such determination, enable adaptation of the adaptive response.

In some of such embodiments, controller 42 may determine a degree of convergence of adaptive responsive W(z) by monitoring adaptive response W(z), as shown in FIG. 4. FIG. 4 is a flow chart of an example method 400 for selectively enabling and disabling adaptation of ANC circuit 30 based on monitoring of adaptive response W(z), in accordance with embodiments of the present disclosure. According to some embodiments, method 400 begins at step 402. As noted above, teachings of the present disclosure are implemented in a variety of configurations of wireless telephone 10. As such, the preferred initialization point for method 400 and the order of the steps comprising method 400 may depend on the implementation chosen.

At step 402, controller 42 may enable response W(z) to adapt for a first period of time (e.g., 1000 milliseconds). At step 404, at the end of the first period of time, controller 42 may record information indicative of response W(z), such as the response itself or the coefficients of W coefficient control block 31.

At step 406, controller 42 may continue to enable response W(z) to adapt for a second period of time (e.g., 100 milliseconds). At step 408, the end of the second period of time, controller 42 may record information indicative of response W(z), such as the response itself or the coefficients of W coefficient control block 31.

At step 410, controller 42 may compare information indicative of response W(z) at the end of the second period of time to the information indicative of response W(z) recorded at the end of the first period of time to determine the degree of convergence of response W(z). If information indicative of response W(z) at the end of the second period of time is within a predetermined threshold error of the information indicative of response W(z) recorded at the end of the first period of time, controller 42 may determine that response W(z) is substantially converged, and may proceed to step 412. Otherwise, controller 42 may determine that response W(z) is not substantially converged, and may proceed again to step 406.

At step 412, in response to the determination that response W(z) is substantially converged, controller 42 may disable adaptation of response W(z) and power down one or more components associated with adaptation of response W(z) for a period of time (e.g., 1000 milliseconds). At step 414, after adaptation of response W(z) has been disabled for the period of time, controller 42 may enable response W(z) to adapt for an additional period of time (e.g., 100 milliseconds). At step 416, at the end of the additional period of time, controller 42 may record information indicative of response W(z), such as the response itself or the coefficients of W coefficient control block 31.

At step 418, controller 42 may compare information indicative of response W(z) at the end of the additional period of time to the information indicative of response W(z) recorded at the end of the period of time in which adaptation of response W(z) was most-recently enabled to determine the degree of convergence of response W(z). If information indicative of response W(z) at the end of the additional period of time is within a predetermined threshold error of the information indicative of response W(z) recorded at the end of the period of time in which adaptation of response W(z) was most-recently enabled, controller 42 may determine that response W(z) is substantially converged, and may proceed to step 412. Otherwise, controller 42 may determine that response W(z) is not substantially converged, and may proceed again to step 402.

Although FIG. 4 discloses a particular number of steps to be taken with respect to method 400, method 400 may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using wireless telephone 10 or any other system operable to implement method 400. In certain embodiments, method 400 may be implemented partially or fully in software and/or firmware embodied in computer-readable media and executable by a controller.

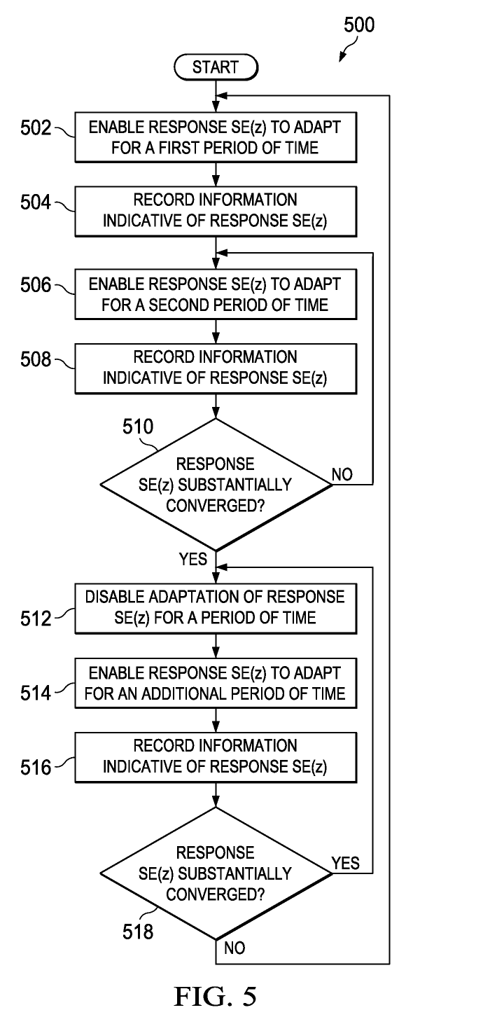

In addition or alternatively, controller 42 may determine a degree of convergence of adaptive responsive SE(z) by monitoring adaptive response SE(z), as shown in FIG. 5. FIG. 5 is a flow chart of an example method 500 for selectively enabling and disabling adaptation of ANC circuit 30 based on monitoring of adaptive response SE(z), in accordance with embodiments of the present disclosure. According to some embodiments, method 500 begins at step 502. As noted above, teachings of the present disclosure are implemented in a variety of configurations of wireless telephone 10. As such, the preferred initialization point for method 500 and the order of the steps comprising method 500 may depend on the implementation chosen.

At step 502, controller 42 may enable response SE(z) to adapt for a first period of time (e.g., 100 milliseconds). At step 504, at the end of the first period of time, controller 42 may record information indicative of response SE(z), such as the response itself or the coefficients of SE coefficient control block 33.

At step 506, controller 42 may continue to enable response SE(z) to adapt for a second period of time (e.g., 10 milliseconds). At step 508, the end of the second period of time, controller 42 may record information indicative of response SE(z), such as the response itself or the coefficients of SE coefficient control block 33.

At step 510, controller 42 may compare information indicative of response SE(z) at the end of the second period of time to the information indicative of response SE(z) recorded at the end of the first period of time to determine the degree of convergence of response SE(z). If information indicative of response SE(z) at the end of the second period of time is within a predetermined threshold error of the information indicative of response SE(z) recorded at the end of the first period of time, controller 42 may determine that response SE(z) is substantially converged, and may proceed to step 512. Otherwise, controller 42 may determine that response SE(z) is not substantially converged, and may proceed again to step 506.

At step 512, in response to the determination that response SE(z) is substantially converged, controller 42 may disable adaptation of response SE(z) and power down one or more components associated with adaptation of response SE(z) for a period of time (e.g., 100 milliseconds). At step 514, after adaptation of response SE(z) has been disabled for the period of time, controller 42 may enable response SE(z) to adapt for an additional period of time (e.g., 10 milliseconds). At step 516, at the end of the additional period of time, controller 42 may record information indicative of response SE(z), such as the response itself or the coefficients of SE coefficient control block 33.

At step 518, controller 42 may compare information indicative of response SE(z) at the end of the additional period of time to the information indicative of response SE(z) recorded at the end of the period of time in which adaptation of response SE(z) was most-recently enabled to determine the degree of convergence of response SE(z). If information indicative of response SE(z) at the end of the additional period of time is within a predetermined threshold error of the information indicative of response SE(z) recorded at the end of the period of time in which adaptation of response SE(z) was most-recently enabled, controller 42 may determine that response SE(z) is substantially converged, and may proceed to step 512. Otherwise, controller 42 may determine that response SE(z) is not substantially converged, and may proceed again to step 502.

Although FIG. 5 discloses a particular number of steps to be taken with respect to method 500, method 500 may be executed with greater or fewer steps than those depicted in FIG. 5. In addition, although FIG. 5 discloses a certain order of steps to be taken with respect to method 500, the steps comprising method 500 may be completed in any suitable order.

Method 500 may be implemented using wireless telephone 10 or any other system operable to implement method 500. In certain embodiments, method 500 may be implemented partially or fully in software and/or firmware embodied in computer-readable media and executable by a controller.

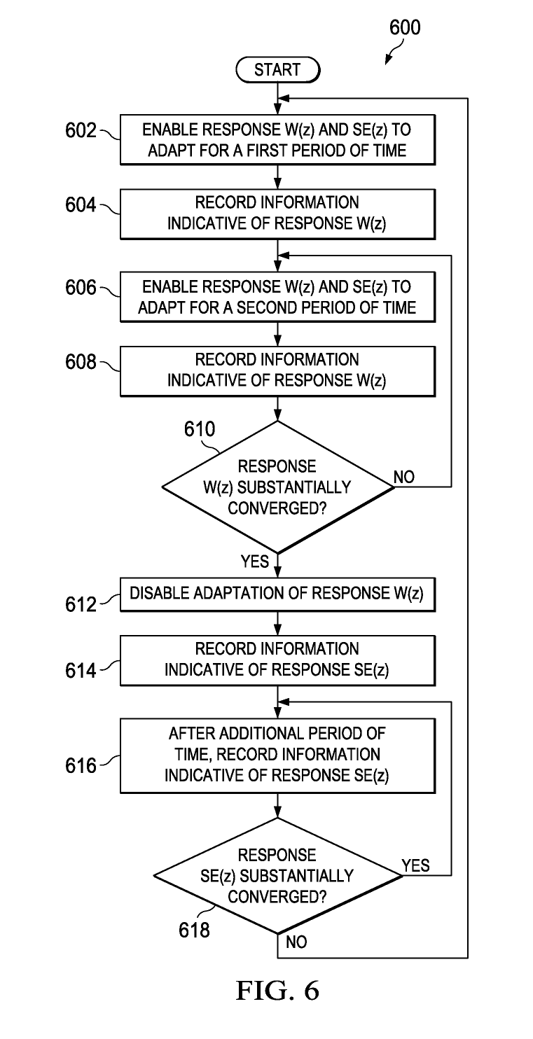

In addition or alternatively, controller 42 may determine a degree of convergence of adaptive responsive W(z) by monitoring both adaptive responses W(z) and SE(z), as shown in FIG. 6. FIG. 6 is a flow chart of an example method 600 for selectively enabling and disabling adaptation of ANC circuit 30 based on monitoring of adaptive responses W(z) and SE(z), in accordance with embodiments of the present disclosure. According to some embodiments, method 600 begins at step 602. As noted above, teachings of the present disclosure are implemented in a variety of configurations of wireless telephone 10. As such, the preferred initialization point for method 600 and the order of the steps comprising method 600 may depend on the implementation chosen.

At step 602, controller 42 may enable responses W(z) and SE(z) to adapt for a first period of time. At step 604, at the end of the first period of time, controller 42 may record information indicative of response W(z), such as the response itself or the coefficients of W coefficient control block 31.

At step 606, controller 42 may continue to enable responses W(z) and SE(z) to adapt for a second period of time. At step 608, the end of the second period of time, controller 42 may record information indicative of response W(z), such as the response itself or the coefficients of W coefficient control block 31.

At step 610, controller 42 may compare information indicative of response W(z) at the end of the second period of time to the information indicative of response W(z) recorded at the end of the first period of time to determine the degree of convergence of response W(z). If information indicative of response W(z) at the end of the second period of time is within a predetermined threshold error of the information indicative of response W(z) recorded at the end of the first period of time, controller 42 may determine that response W(z) is substantially converged, and may proceed to step 612. Otherwise, controller 42 may determine that response W(z) is not substantially converged, and may proceed again to step 606.

At step 612, in response to the determination that response W(z) is substantially converged, controller 42 may disable adaptation of response W(z) and power down one or more components associated with adaptation of response W(z), but may enable response SE(z) to continue to adapt. At step 614, controller 42 may record information indicative of response SE(z), such as the response itself or the coefficients of SE coefficient control block 33.

At step 616, after an additional period of time, controller 42 may again record information indicative of response SE(z), such as the response itself or the coefficients of SE coefficient control block 33. At step 618, controller 42 may compare information indicative of response SE(z) at the end of the additional period of time to the information indicative of response SE(z) recorded prior to the additional period of time. If information indicative of response SE(z) at the end of the additional period of time is within a predetermined threshold error of the information indicative of response SE(z) recorded prior to the additional period of time, controller 42 may determine that response SE(z) is substantially converged, and may proceed again to step 616. Otherwise, controller 42 may determine that response SE(z) is not substantially converged, and may proceed again to step 602.

Although FIG. 6 discloses a particular number of steps to be taken with respect to method 600, method 600 may be executed with greater or fewer steps than those depicted in FIG. 6. In addition, although FIG. 6 discloses a certain order of steps to be taken with respect to method 600, the steps comprising method 600 may be completed in any suitable order.

Method 600 may be implemented using wireless telephone 10 or any other system operable to implement method 600. In certain embodiments, method 600 may be implemented partially or fully in software and/or firmware embodied in computer-readable media and executable by a controller.

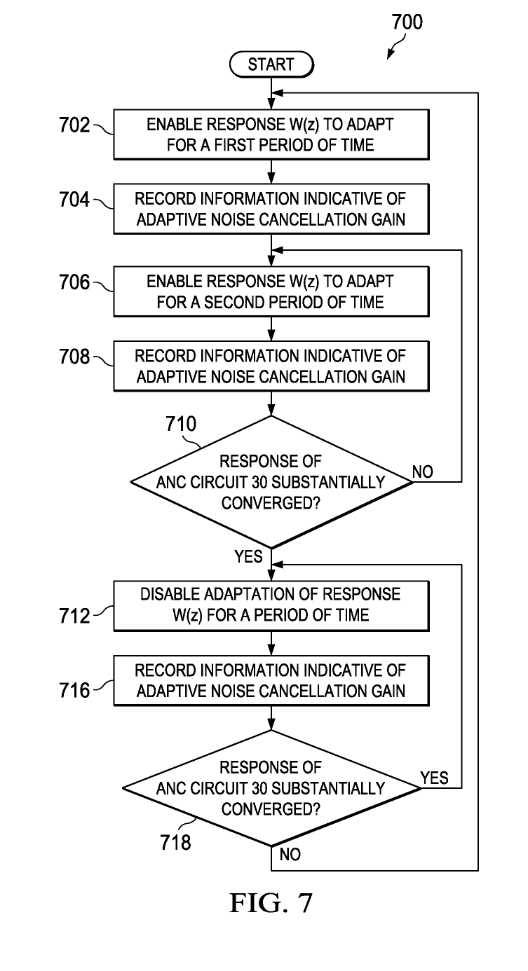

In these and other embodiments, controller 42 may, as described in greater detail below with respect to FIG. 7, be configured to determine the degree of convergence of the adaptive response by determining an adaptive noise cancellation gain of ANC circuit 30 at a first time, determining the adaptive noise cancellation gain at a second time, and comparing the adaptive noise cancellation gain at the first time to the adaptive noise cancellation gain at the second time. The adaptive noise cancellation gain may be defined as a synthesized reference microphone signal synref divided by the playback corrected error, and synthesized reference microphone signal synref may be based on a difference between the playback corrected error and the output signal. For example, the output signal generated by combiner 26 may be filtered by filter 34C which applies a response SE_{COPY}(z) which is a copy of the response SE(z) of filter 34A. The filtered output signal may then be subtracted from the playback corrected error by combiner 38 in order to generate synthesized reference microphone signal synref. In such embodiments, controller 42 may determine the degree of convergence to be above the particular threshold if the adaptive noise cancellation gain at the second time is within a threshold error of the adaptive noise cancellation gain at the first time, and responsive to such determination, disable adaptation of the adaptive response (e.g., W(z) and/or SE(z)). Similarly, controller 42 may determine the degree of convergence to be below the particular threshold if the adaptive noise cancellation gain at the end of the second time is not within the threshold error, and responsive to such determination, enable adaptation of the adaptive response.

FIG. 7 is a flow chart of an example method 700 for selectively enabling and disabling adaptation of ANC circuit 30 based on monitoring of adaptive noise cancellation gain of ANC circuit 30, in accordance with embodiments of the present disclosure. According to some embodiments, method 700 begins at step 702. As noted above, teachings of the present disclosure are implemented in a variety of configurations of wireless telephone 10. As such, the preferred initialization point for method 700 and the order of the steps comprising method 700 may depend on the implementation chosen.

At step 702, controller 42 may enable response W(z) to adapt for a first period of time. At step 704, at the end of the first period of time, controller 42 may record information indicative of the adaptive noise cancellation gain (e.g., the response of the adaptive noise cancellation gain as a function of frequency).

At step 706, controller 42 may continue to enable response W(z) to adapt for a second period of time. At step 708, the end of the second period of time, controller 42 may record information indicative of the adaptive noise cancellation gain (e.g., the response of the adaptive noise cancellation gain as a function of frequency).

At step 710, controller 42 may compare information indicative of the adaptive noise cancellation gain at the end of the second period of time to the information indicative of the adaptive noise cancellation gain recorded at the end of the first period of time to determine the degree of convergence of ANC circuit 30. If information indicative of the adaptive noise cancellation gain at the end of the second period of time is within a predetermined threshold error of the information indicative of the adaptive noise cancellation gain recorded at the end of the first period of time, controller 42 may determine that ANC circuit 30 is substantially converged, and may proceed to step 712. Otherwise, controller 42 may determine that ANC circuit 30 is not substantially converged, and may proceed again to step 706.

At step 712, in response to the determination that ANC circuit 30 is substantially converged, controller 42 may disable adaptation of response W(z) and power down one or more components associated with adaptation of response W(z) for an additional period of time. At step 716, at the end of the additional period of time, controller 42 may record information indicative of the adaptive noise cancellation gain (e.g., the response of the adaptive noise cancellation gain as a function of frequency).

At step 718, controller 42 may compare information indicative of the adaptive noise cancellation gain at the end of the additional period of time to the information indicative of the adaptive noise cancellation gain recorded at the end of the period of time in which adaptation of response W(z) was most-recently enabled to determine the degree of convergence of ANC circuit 30. If information indicative of the adaptive noise cancellation gain at the end of the additional period of time is within a predetermined threshold error of the information indicative of the adaptive noise cancellation gain recorded at the end of the period of time in which adaptation of response W(z) was most-recently enabled, controller 42 may determine that ANC circuit 30 is substantially converged, and may proceed to step 712. Otherwise, controller 42 may determine that ANC circuit 30 is not substantially converged, and may proceed again to step 702. Although FIG. 7 discloses a particular number of steps to be taken with respect to method 700, method 700 may be executed with greater or fewer steps than those depicted in FIG. 7. In addition, although FIG. 7 discloses a certain order of steps to be taken with respect to method 700, the steps comprising method 700 may be completed in any suitable order.

Method 700 may be implemented using wireless telephone 10 or any other system operable to implement method 700. In certain embodiments, method 700 may be implemented partially or fully in software and/or firmware embodied in computer-readable media and executable by a controller.

In addition or alternatively to monitoring the adaptive noise cancellation gain, controller 42 may be configured to determine the degree of convergence of the adaptive response by determining a cross-correlation between the reference microphone signal and the playback corrected error. For example, controller 42 may determine the degree of convergence to be above the particular threshold if the cross-correlation is lesser than a threshold cross-correlation, and responsive to such determination, disable adaptation of the adaptive response (e.g., W(z) and/or SE(z)). Similarly, controller 42 may determine the degree of convergence to be below the particular threshold if the cross-correlation is greater than a threshold cross-correlation, and responsive to such determination, enable adaptation of the adaptive response.

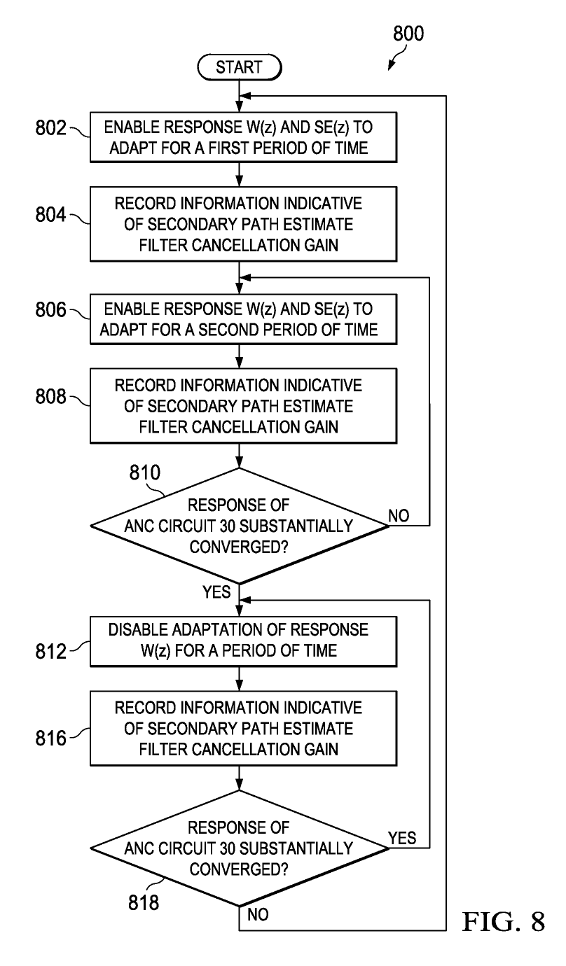

In these and other embodiments, controller 42 may, as described in greater detail below with respect to FIG. 8, be configured to determine the degree of convergence of the adaptive response by adapting the adaptive response for a first period of time, determining a secondary path estimate filter cancellation gain at the end of the first period of time, adapting the adaptive response for a second period of time, determining the secondary path estimate filter cancellation gain at the end of the second period of time, and comparing the secondary path estimate filter cancellation gain at the end of the first period of time to the secondary path estimate filter cancellation gain at the end of the second period of time. The secondary path estimate filter cancellation gain may be defined as the playback corrected error divided by error microphone signal err. In such embodiments, controller 42 may determine the degree of convergence to be above the particular threshold if the secondary path estimate filter cancellation gain at the end of the second period of time is within a threshold error of the secondary path estimate filter cancellation gain at the end of the first period of time, and responsive to such determination, disable adaptation of the adaptive response (e.g., W(z) and/or SE(z)). Similarly, controller 42 may determine the degree of convergence to be below the particular threshold if the secondary path estimate filter cancellation gain at the end of the second period of time is not within the threshold error, and responsive to such determination, enable adaptation of the adaptive response.

FIG. 8 is a flow chart of an example method 800 for selectively enabling and disabling adaptation of ANC circuit 30 based on monitoring of a secondary path estimate filter cancellation gain of ANC circuit 30, in accordance with embodiments of the present disclosure. According to some embodiments, method 800 begins at step 802. As noted above, teachings of the present disclosure are implemented in a variety of configurations of wireless telephone 10. As such, the preferred initialization point for method 800 and the order of the steps comprising method 800 may depend on the implementation chosen.

At step 802, controller 42 may enable responses W(z) and SE(z) to adapt for a first period of time. At step 804, at the end of the first period of time, controller 42 may record information indicative of the secondary path estimate filter cancellation gain (e.g., the response of the secondary path estimate filter cancellation gain as a function of frequency).

At step 806, controller 42 may continue to enable responses W(z) and SE(z) to adapt for a second period of time. At step 808, at the end of the second period of time, controller 42 may record information indicative of the secondary path estimate filter cancellation gain (e.g., the response of the secondary path estimate filter cancellation gain as a function of frequency).

At step 810, controller 42 may compare information indicative of the secondary path estimate filter cancellation gain at the end of the second period of time to the information indicative of the secondary path estimate filter cancellation gain recorded at the end of the first period of time to determine the degree of convergence of ANC circuit 30. If information indicative of the secondary path estimate filter cancellation gain at the end of the second period of time is within a predetermined threshold error of the information indicative of the secondary path estimate filter cancellation gain recorded at the end of the first period of time, controller 42 may determine that ANC circuit 30 is substantially converged, and may proceed to step 812. Otherwise, controller 42 may determine that ANC circuit 30 is not substantially converged, and may proceed again to step 806.

At step 812, in response to the determination that ANC circuit 30 is substantially converged, controller 42 may disable adaptation of response W(z) and power down one or more components associated with adaptation of response W(z) for an additional period of time. At step 816, at the end of the additional period of time, controller 42 may record information indicative of the secondary path estimate filter cancellation gain (e.g., the response of the secondary path estimate filter cancellation gain as a function of frequency).

At step 818, controller 42 may compare information indicative of the secondary path estimate filter cancellation gain at the end of the additional period of time to the information indicative of the secondary path estimate filter cancellation gain recorded at the end of the period of time in which adaptation of responses W(z) and SE(z) was most-recently enabled to determine the degree of convergence of ANC circuit 30. If information indicative of the secondary path estimate filter cancellation gain at the end of the additional period of time is within a predetermined threshold error of the information indicative of the secondary path estimate filter cancellation gain recorded at the end of the period of time in which adaptation of responses W(z) and SE(z) was most-recently enabled, controller 42 may determine that ANC circuit 30 is substantially converged, and may proceed to step 812. Otherwise, controller 42 may determine that ANC circuit 30 is not substantially converged, and may proceed again to step 802.

Although FIG. 8 discloses a particular number of steps to be taken with respect to method 800, method 800 may be executed with greater or fewer steps than those depicted in FIG. 8. In addition, although FIG. 8 discloses a certain order of steps to be taken with respect to method 800, the steps comprising method 800 may be completed in any suitable order.

Method 800 may be implemented using wireless telephone 10 or any other system operable to implement method 800. In certain embodiments, method 800 may be implemented partially or fully in software and/or firmware embodied in computer-readable media and executable by a controller.

In addition or alternatively to monitoring the secondary path estimate filter cancellation gain, controller 42 may be configured to determine the degree of convergence of the adaptive response by determining a cross-correlation between the source audio signal ds/ia and the playback corrected error. For example, controller 42 may determine the degree of convergence to be above the particular threshold if the cross-correlation is lesser than a threshold cross-correlation, and responsive to such determination, disable adaptation of the adaptive response (e.g., W(z) and/or SE(z)). Similarly, controller 42 may determine the degree of convergence to be below the particular threshold if the cross-correlation is greater than a threshold cross-correlation, and responsive to such determination, enable adaptation of the adaptive response.

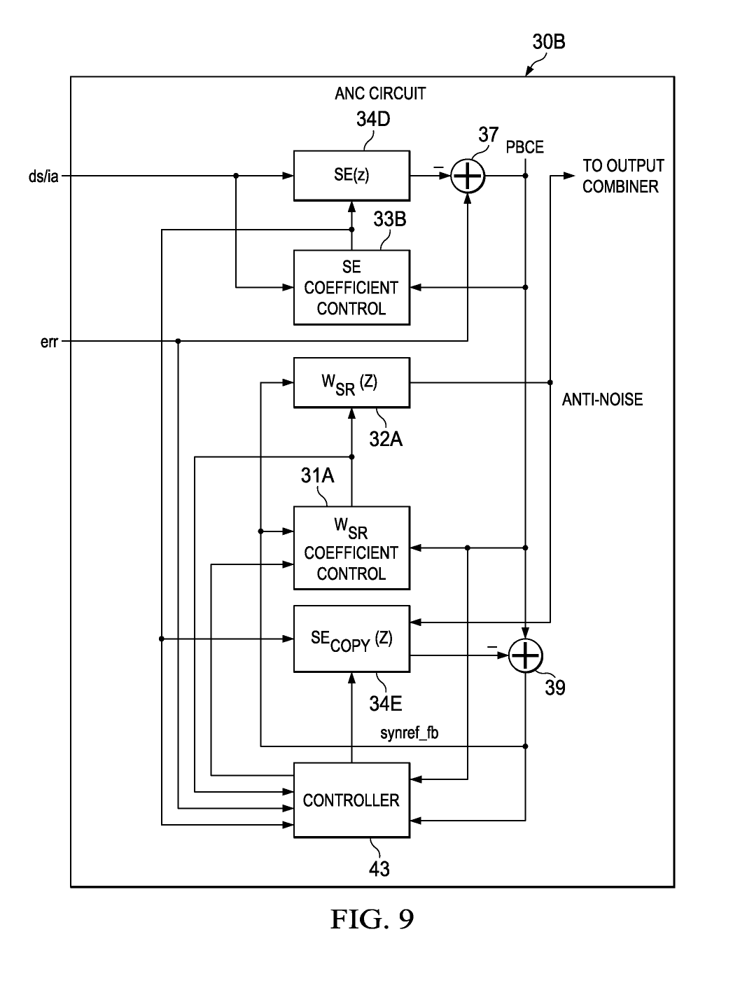

Although FIGS. 2 and 3 depict a feedforward ANC system in which an anti-noise signal is generated from a filtered reference microphone signal, any other suitable ANC system employing an error microphone may be used in connection with the methods and systems disclosed herein. For example, in some embodiments, an ANC circuit employing feedback ANC, in which anti-noise is generated from a playback corrected error signal, may be used instead of or in addition to feedforward ANC, as depicted in FIGS. 2 and 3. An example of a feedback ANC circuit 30B is depicted in FIG. 9.

As shown in FIG. 9, feedback adaptive filter 32A may receive a synthesized reference feedback signal synref_fb and under ideal circumstances, may adapt its transfer function W_{SR}(z) to generate the anti-noise signal, which may be provided to an output combiner that combines the anti-noise signal with the audio to be reproduced by the transducer, as exemplified by combiner 26 of FIG. 2. In some embodiments, selected components of ANC circuit 30 of FIG. 3 and ANC circuit 30B of FIG. 9 may be combined into a single ANC system, such that feedforward anti-noise signal component generated by ANC circuit 30 and the feedback anti-noise generated by ANC circuit 30B may combine to generate the anti-noise for the overall ANC system. Synthesized reference feedback signal synref_fb may be generated by combiner 39 based on a difference between a signal that includes the error microphone signal (e.g., the playback corrected error) and the anti-noise signal as shaped by a copy SE_{COPY}(z) of an estimate of the response of path S(z) provided by filter 34E. The coefficients of feedback adaptive filter 32A may be controlled by a W_{SR} coefficient control block 31A that uses a correlation of signals to determine the response of feedback adaptive filter 32A, which generally minimizes the error, in a least-mean squares sense, between those components of synthesized reference feedback signal synref_fb present in error microphone signal err. The signals compared by W_{SR} coefficient control block 31A may be the synthesized reference feedback signal synref_fb and another signal that includes error microphone signal err. By minimizing the difference between the synthesized reference feedback signal synref_fb and error microphone signal err, feedback adaptive filter 32A may adapt to the desired response.

To implement the above, adaptive filter 34D may have coefficients controlled by SE coefficient control block 33B, which may compare downlink audio signal ds and/or internal audio signal ia and error microphone signal err after removal of the above-described filtered downlink audio signal ds and/or internal audio signal ia, that has been filtered by adaptive filter 34D to represent the expected downlink audio delivered to error microphone E, and which is removed from the output of adaptive filter 34D by a combiner 37 to generate the playback corrected error. SE coefficient control block 33B correlates the actual downlink speech signal ds and/or internal audio signal ia with the components of downlink audio signal ds and/or internal audio signal ia that are present in error microphone signal err. Adaptive filter 34D may thereby be adapted to generate a signal from downlink audio signal ds and/or internal audio signal ia, that when subtracted from error microphone signal err, contains the content of error microphone signal err that is not due to downlink audio signal ds and/or internal audio signal ia.

Also as shown in FIG. 9, ANC circuit 30B may include a controller 43. As described in greater detail below, controller 43 may be configured to determine a degree of convergence of an adaptive response (e.g., response W_{SR}(z) and/or response SE(z)) of ANC circuit 30B. Such determination may be made based on one or more signals associated with ANC circuit 30B, including without limitation the audio output signal, error microphone signal err, the playback corrected error, coefficients generated by W_{SR} coefficient control block 31A, and coefficients generated by SE coefficient control block 33B. If the degree of convergence of the adaptive response is below a particular threshold, controller 43 may enable adaptation of the adaptive response. On the other hand, if the degree of convergence of the adaptive response is above a particular threshold, controller 43 may disable adaptation of the adaptive response. In some embodiments, controller 43 may disable adaptation of an adaptive response by disabling a coefficient control block (e.g., W_{SR} coefficient control block 31A and/or SE coefficient control block 33B) associated with the adaptive response. In these and other embodiments, controller 43 may disable adaptation of an adaptive response (e.g., response W_{SR}(z)) by disabling filter 34E. In these and other embodiments, controller 43 may disable adaptation of an adaptive response (e.g., W_{SR}(z)) by disabling oversight detectors of ANC circuit 30B used to ensure stability in the adaptation of response W(z).

In some embodiments, controller 43 may, in a manner similar or analogous to that described in greater detail above with respect to FIGS. 4-6, be configured to determine a degree of convergence of an adaptive response (e.g., W_{SR}(z) and/or SE(z)) by adapting the adaptive response for a first period of time, determining coefficients of an adaptive coefficient control block (e.g., W_{SR} coefficient control block 31A and/or SE coefficient control block 33B) associated with the adaptive response at the end of the first period of time, adapting the adaptive response for a second period of time, determining coefficients of the adaptive coefficient control block at the end of the second period of time, and comparing the coefficients of the adaptive coefficient control block at the end of the first period of time to the coefficients of the adaptive coefficient control block at the end of the second period of time. For example, controller 43 may determine the degree of convergence to be above the particular threshold if the coefficients of the adaptive coefficient control block at the end of the second period of time are within a threshold error of the coefficients of the adaptive coefficient control block at the end of the first period of time, and responsive to such determination, disable adaptation of the adaptive response (e.g., W_{SR}(z) and/or SE(z)). Similarly, controller 43 may determine the degree of convergence to be below the particular threshold if the coefficients of the adaptive coefficient control block at the end of the second period of time are not within the threshold error, and responsive to such determination, enable adaptation of the adaptive response. In addition, in some embodiments, controller 43 may, in a manner similar or analogous to that described in greater detail above with respect to FIGS. 7 and 8, be configured to determine a degree of convergence of an adaptive response (e.g., W_{SR}(z) and/or SE(z)) by monitoring of an adaptive noise cancellation gain of ANC circuit 30B and/or a secondary path estimate filter cancellation gain of ANC circuit 30B.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An integrated circuit for implementing at least a portion of a personal audio device, comprising:
an output for providing an output signal to a transducer including both a source audio signal for playback to a listener and an anti-noise signal for countering the effect of ambient audio sounds in an acoustic output of the transducer;
an error microphone input for receiving an error microphone signal indicative of the output of the transducer and the ambient audio sounds at the transducer; and
a processing circuit that implements:
an anti-noise generating filter having a response that generates the anti-noise signal based on the error microphone signal;
a secondary path estimate filter configured to model an electro-acoustic path of the source audio signal and having a response that generates a secondary path estimate from the source audio signal, wherein at least one of the response of the anti-noise generating filter and the response of the secondary path estimate filter is an adaptive response shaped by an adaptive coefficient control block;
the adaptive coefficient control block comprising at least one of:
a filter coefficient control block that shapes the response of the anti-noise generating filter by adapting the response of the anti-noise generating filter to minimize the ambient audio sounds in the error microphone signal; and
a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate; and
a controller configured to:
determine a degree of convergence of the adaptive response;
enable adaptation of the adaptive response if the degree of convergence of the adaptive response is below a particular threshold; and
disable adaptation of the adaptive response if the degree of convergence of the adaptive response is above a particular threshold.

2. The integrated circuit of claim 1, the controller further configured to determine the degree of convergence of the adaptive response by:
adapting the adaptive response for a first period of time, and determining coefficients of the adaptive coefficient control block at the end of the first period of time;
adapting the adaptive response for a second period of time, and determining coefficients of the adaptive coefficient control block at the end of the second period of time; and
comparing the coefficients of the adaptive coefficient control block at the end of the first period of time to the coefficients of the adaptive coefficient control block at the end of the second period of time.

3. The integrated circuit of claim 2, the controller further configured to:
determine the degree of convergence to be above the particular threshold if the coefficients of the adaptive coefficient control block at the end of the second period of time are within a threshold error of the coefficients of the adaptive coefficient control block at the end of the first period of time; and
determine the degree of convergence to be below the particular threshold if the coefficients of the adaptive coefficient control block at the end of the second period of time are not within the threshold error.

4. The integrated circuit of claim 1, the controller further configured to determine the degree of convergence of the adaptive response by:
determining an adaptive noise cancellation gain at a first time, wherein the adaptive noise cancellation gain is defined as a synthesized reference microphone signal divided by the playback corrected error, and wherein the synthesized reference microphone signal is based on a difference between the playback corrected error and the output signal;
determining the adaptive noise cancellation gain at a second time; and
comparing the adaptive noise cancellation gain at the first time to the adaptive noise cancellation gain at the second time.

5. The integrated circuit of claim 4, the controller further configured to:
determine the degree of convergence to be above the particular threshold if the adaptive noise cancellation gain at the second time is within a threshold error of the adaptive noise cancellation gain at the first time; and
determine the degree of convergence to be below the particular threshold if the adaptive noise cancellation gain at the end of the second time is not within the threshold error.

6. The integrated circuit of claim 1, wherein the adaptive response comprises the response of the secondary path estimate filter and wherein the controller is further configured to determine the degree of convergence of the adaptive response by:
adapting the adaptive response for a first period of time, and determining a secondary path estimate filter cancellation gain at the end of the first period of time, wherein the secondary path estimate filter cancellation gain is defined as the playback corrected error divided by the error microphone signal;
adapting the adaptive response for a second period of time, and determining the secondary path estimate filter cancellation gain at the end of the second period of time; and
comparing the secondary path estimate filter cancellation gain at the end of the first period of time to the secondary path estimate filter cancellation gain at the end of the second period of time.

7. The integrated circuit of claim 6, the controller further configured to:
determine the degree of convergence to be above the particular threshold if the secondary path estimate filter cancellation gain at the end of the second period of time is within a threshold error of the secondary path estimate filter cancellation gain at the end of the first period of time; and
determine the degree of convergence to be below the particular threshold if the secondary path estimate filter cancellation gain at the end of the second period of time is not within the threshold error.

8. The integrated circuit of claim 1, wherein the anti-noise generating filter comprises a feedback filter having a response that generates the anti-noise signal from a synthesized reference feedback signal, the synthesized reference feedback signal based on a difference between the error microphone signal and the anti-noise signal.

9. The integrated circuit of claim 8, wherein the filter coefficient control block comprises a feedback coefficient control block that shapes the response of the feedback filter in conformity with the error microphone signal and the synthesized reference feedback signal by adapting the response of the feedback filter to minimize the ambient audio sounds in the error microphone signal.

10. The integrated circuit of claim 1, further comprising a reference microphone input for receiving a reference microphone signal indicative of the ambient audio sounds, and wherein the anti-noise generating filter comprises a feedforward filter having a response that generates the anti-noise signal from the reference microphone signal.

11. The integrated circuit of claim 10, wherein the filter coefficient control block comprises a feedforward coefficient control block that shapes the response of the feedforward filter in conformity with the error microphone signal and the reference microphone signal by adapting the response of the feedforward filter to minimize the ambient audio sounds in the error microphone signal.

12. The integrated circuit of claim 10, wherein the controller is further configured to determine the degree of convergence of the adaptive response by determining a cross-correlation between the reference microphone signal and the playback corrected error.

13. The integrated circuit of claim 12, wherein the controller is further configured to:
determine the degree of convergence to be above the particular threshold if the cross-correlation is lesser than a threshold cross-correlation; and
determine the degree of convergence to be below the particular threshold if the cross-correlation is greater than a threshold cross-correlation.

14. The integrated circuit of claim 1, wherein the controller is further configured to determine the degree of convergence of the adaptive response by determining a cross-correlation between the source audio signal and the playback corrected error.

15. The integrated circuit of claim 14, wherein the controller is further configured to:
determine the degree of convergence to be above the particular threshold if the cross-correlation is lesser than a threshold cross-correlation; and
determine the degree of convergence to be below the particular threshold if the cross-correlation is greater than a threshold cross-correlation.

16. The integrated circuit of claim 1, wherein the controller is further configured to disable adaptation of the adaptive response by disabling the adaptive coefficient control block.

17. The integrated circuit of claim 1, wherein:
the integrated circuit comprises one or more copies of the secondary path estimate filter; and
the controller further is configured to disable adaptation of the adaptive response by disabling the one or more copies of the secondary path estimate filter.

18. A method for canceling ambient audio sounds in the proximity of a transducer of a personal audio device, the method comprising:
receiving an error microphone signal indicative of an acoustic output of the transducer and the ambient audio sounds at the transducer;
adaptively generating an anti-noise signal to reduce the presence of the ambient audio sounds by adapting an adaptive response of an adaptive noise cancellation system to minimize the ambient audio sounds at the acoustic output of the transducer, wherein adaptively generating the anti-noise signal comprises:
generating the anti-noise signal based on at least the error microphone signal with an anti-noise generating filter;
generating a secondary path estimate from the source audio signal with a secondary path estimate filter for modeling an electro-acoustic path of a source audio signal; and
at least one of:
adaptively generating the anti-noise signal by adapting the response of the anti-noise generating filter to minimize the ambient audio sounds in the error microphone signal, wherein the adaptive response comprises the response of the anti-noise generating filter; and
adaptively generating the secondary path estimate by shaping a response of the secondary path estimate filter in conformity with the source audio signal and a playback corrected error by adapting the response of the secondary path estimate filter to minimize the playback corrected error, wherein the playback corrected error is based on a difference between the error microphone signal and the secondary path estimate, wherein the adaptive response comprises the response of the secondary path estimate filter;
combining the anti-noise signal with a source audio signal to generate an output signal provided to the transducer;
determining a degree of convergence of the adaptive response;
enabling adaptation of the adaptive response if the degree of convergence of the adaptive response is below a particular threshold; and
disabling adaptation of the adaptive response if the degree of convergence of the adaptive response is above a particular threshold.

19. The method of claim 18, wherein determining the degree of convergence of the adaptive response comprises:
adapting the adaptive response for a first period of time, and determining coefficients of an adaptive coefficient control block for controlling the adaptive response at the end of the first period of time;
adapting the adaptive response for a second period of time, and determining coefficients of the adaptive coefficient control block at the end of the second period of time; and
comparing the coefficients of the adaptive coefficient control block at the end of the first period of time to the coefficients of the adaptive coefficient control block at the end of the second period of time.

20. The method of claim 19, further comprising:
determining the degree of convergence to be above the particular threshold if the coefficients of the adaptive coefficient control block at the end of the second period of time are within a threshold error of the coefficients of the adaptive coefficient control block at the end of the first period of time; and
determining the degree of convergence to be below the particular threshold if the coefficients of the adaptive coefficient control block at the end of the second period of time are not within the threshold error.

21. The method of claim 20, wherein determining the degree of convergence of the adaptive response comprises:
determining an adaptive noise cancellation gain at a first time, wherein the adaptive noise cancellation gain is defined as a synthesized reference microphone signal divided by the playback corrected error, and wherein the synthesized reference microphone signal is based on a difference between the playback corrected error and the output signal;
determining the adaptive noise cancellation gain at a second time; and
comparing the adaptive noise cancellation gain at the first time to the adaptive noise cancellation gain at the second time.

22. The method of claim 21, further comprising:
determining the degree of convergence to be above the particular threshold if the adaptive noise cancellation gain at the second time is within a threshold error of the adaptive noise cancellation gain at the first time; and
determining the degree of convergence to be below the particular threshold if the adaptive noise cancellation gain at the end of the second time is not within the threshold error.

23. The method of claim 22, wherein the adaptive response comprises the response of the secondary path estimate filter and wherein determining the degree of convergence of the response comprises:
adapting the adaptive response for a first period of time, and determining a secondary path estimate filter cancellation gain at the end of the first period of time, wherein the secondary path estimate filter cancellation gain is defined as the playback corrected error divided by the error microphone signal;
adapting the adaptive response for second period of time, and determining the secondary path estimate filter cancellation gain the end of the second period of time; and
comparing the secondary path estimate filter cancellation gain at the end of the first period of time to the secondary path estimate filter cancellation gain at the end of the second period of time.

24. The method of claim 23, further comprising:
determining the degree of convergence to be above the particular threshold if the secondary path estimate filter cancellation gain at the end of the second period of time is within a threshold error of the secondary path estimate filter cancellation gain at the end of the first period of time; and
determining the degree of convergence to be below the particular threshold if the secondary path estimate filter cancellation gain at the end of the second period of time is not within the threshold error.

25. The method of claim 18, wherein the anti-noise generating filter comprises a feedback filter having a response that generates the anti-noise signal from a synthesized reference feedback signal, the synthesized reference feedback signal based on a difference between the error microphone signal and the anti-noise signal.

26. The method of claim 25, wherein the filter coefficient control block comprises a feedback coefficient control block that shapes the response of the feedback filter in conformity with the error microphone signal and the synthesized reference feedback signal by adapting the response of the feedback filter to minimize the ambient audio sounds in the error microphone signal.

27. The method of claim 18, further comprising receiving a reference microphone signal indicative of the ambient audio sounds; and wherein the anti-noise generating filter comprises a feedforward filter having a response that generates the anti-noise signal from the reference microphone signal.

28. The method of claim 27, wherein the filter coefficient control block comprises a feedforward coefficient control block that shapes the response of the feedforward filter in conformity with the error microphone signal and the reference microphone signal by adapting the response of the feedforward filter to minimize the ambient audio sounds in the error microphone signal.

29. The method of claim 18, further comprising determining the degree of convergence of the adaptive response by determining a cross-correlation between the reference microphone signal and the playback corrected error.

30. The method of claim 29, the controller further configured to:
determine the degree of convergence to be above the particular threshold if the cross-correlation is lesser than a threshold cross-correlation; and
determine the degree of convergence to be below the particular threshold if the cross-correlation is greater than a threshold cross-correlation.

31. The method of claim 18, further comprising determining the degree of convergence of the adaptive response by determining a cross-correlation between the source audio signal and the playback corrected error.

32. The method of claim 31, further comprising:
determining the degree of convergence to be above the particular threshold if the cross-correlation is lesser than a threshold cross-correlation; and
determining the degree of convergence to be below the particular threshold if the cross-correlation is greater than a threshold cross-correlation.

33. The method of claim 32, further comprising disabling adaptation of the adaptive response by disabling an adaptive coefficient control block for controlling the adaptive response.

34. The method of claim 18, further comprising disabling adaptation of the adaptive response by disabling one or more copies of the secondary path estimate filter.

35. A personal audio device comprising:
a transducer for reproducing an output signal including both a source audio signal for playback to a listener and an anti-noise signal for countering the effects of ambient audio sounds in an acoustic output of the transducer;
an error microphone for generating an error microphone signal indicative of the output of the transducer and the ambient audio sounds at the transducer; and
a processing circuit that implements:
an anti-noise generating filter having a response that generates the anti-noise signal based on the error microphone signal;
a secondary path estimate filter configured to model an electro-acoustic path of the source audio signal and having a response that generates a secondary path estimate from the source audio signal, wherein at least one of the response of the anti-noise generating filter and the response of the secondary path estimate filter is an adaptive response shaped by an adaptive coefficient control block;
the adaptive coefficient control block comprising at least one of:
a filter coefficient control block that shapes the response of the anti-noise generating filter by adapting the response of the anti-noise generating filter to minimize the ambient audio sounds in the error microphone signal; and
a secondary path estimate coefficient control block that shapes the response of the secondary path estimate filter in conformity with the source audio signal and a playback corrected error by adapting the response of the secondary path estimate filter to minimize the playback corrected error; wherein the playback corrected error is based on a difference between the error microphone signal and the secondary path estimate; and
a controller configured to:
determine a degree of convergence of the adaptive response;
enable adaptation of the adaptive response if the degree of convergence of the adaptive response is below a particular threshold; and
disable adaptation of the adaptive response if the degree of convergence of the adaptive response is above a particular threshold.

36. An integrated circuit for implementing at least a portion of a personal audio device, comprising a controller configured to:
determine a degree of convergence of an adaptive response of an adaptive filter in an adaptive noise cancellation system;
enable adaptation of the adaptive response if the degree of convergence of the adaptive response is below a particular threshold; and
disable adaptation of the adaptive response if the degree of convergence of the adaptive response is above a particular threshold.

37. The integrated circuit of claim 36, wherein the adaptive filter comprises a secondary path estimate filter configured to model an electro-acoustic path of a source audio signal and having a response that generates a secondary path estimate from the source audio signal.

38. The integrated circuit of claim 36, wherein the adaptive filter comprises an anti-noise generating filter having a response that generates an anti-noise signal based on an error microphone signal indicative of an output of a transducer and the ambient audio sounds at the transducer.

39. The integrated circuit of claim 36, wherein the anti-noise generating filter comprises a feedback filter having a response that generates the anti-noise signal from a synthesized reference feedback signal, the synthesized reference feedback signal based on a difference between the error microphone signal and the anti-noise signal.

40. The integrated circuit of claim 36, wherein the anti-noise generating filter comprises a feedforward filter having a response that generates the anti-noise signal from a reference microphone signal indicative of ambient audio sounds.
